(19) United States
(12) Patent Application Publication
(10) Pub. No.: US 2009/0011245 A1
(43) Pub. Date: Jan. 8, 2009

(54) In-Mold Decoration Injection Molding Case and Process Thereof

(75) Inventors: Chih-Sheng Tsai, Taipei (TW); Yi-Cheng Shiu, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTeK COMPUTER INC., Taipei (TW)

(21) Appl. No.: 12/144,216

(22) Filed: Jun. 23, 2008

(30) Foreign Application Priority Data
Jul. 2, 2007 (TW) 96124024

(51) Int. Cl. B32B 9/04

(52) U.S. Cl. 428/411.1; 264/247

(57) ABSTRACT

An in-mold decoration (IMD) injection molding case includes a decoration film and a piece of plastic material. The decoration film includes a first plastic film, a graphite film, and a second plastic film. The graphite film is sandwiched between the first plastic film and the second plastic film. The piece of plastic material is combined with the decoration film to form the IMD injection molding case by an IMD injection molding process. An IMD injection molding process is also disclosed.

### RELATED APPLICATIONS

This application claims priority to Taiwan Application Serial Number 96124024, filed Jul. 2, 2007, which is herein incorporated by reference.

### BACKGROUND OF THE INVENTION

1. Field of the Invention

The invention relates to an injection molding case and the process thereof and, more particularly, to an in-mold decoration (IMD) injection molding case and the process thereof.

2. Description of the Related Art

The in-mold decoration (IMD) technology is an automation producing technology by which printing, hot pressing, punching may be performed on the surface of a film, and then the film is combined with a piece of plastic material. The IMD technology may replace or decrease the process of the spraying paint or sticking paper performed on the surface of the plastic product and improve the hue and anti-abrasion strength. Therefore, the IMD technology often is used in the plastic product with high added value such as the panel of a mobile phone, the case of a notebook computer, the case of a personal digital assistant (PDA) and an instrument panel in a motor vehicle.

The electronic elements generated heat in the case of a notebook computer or the put hand often causes temperature of partial case to be uneven, which affects the tactile sensation.

### BRIEF SUMMARY OF THE INVENTION

The objective of the invention is to provide an IMD injection molding case having high heat conductivity and a function of preventing the electromagnetic interference (EMI).

According to the objective of the invention, an IMD injection molding case including a decoration film and a piece of plastic material is provided. The decoration film includes a first plastic film, a second plastic film and a graphite film provided between the first plastic film and the second plastic film. The piece of plastic material may be combined with the decoration film to form the IMD injection molding case by the IMD injection molding process. The piece of plastic material contacts the first plastic film of the decoration film. The decoration film may include a printed ink film provided between the graphite film and the second plastic film. The decoration film may include a plurality of adhesive films provided between the first plastic film and the graphite film and between the graphite film and the second plastic film, respectively, to combine the first plastic film, the graphite film and the second plastic film to form the decoration film. The thickness of the graphite film is preferred to be 0.1 mm to 0.5 mm. The IMD injection molding case may be a case of a notebook computer.

The invention also provides an IMD injection molding process including the following steps. A decoration film is provided. The decoration film includes a first plastic film, a second plastic film and a graphite film provided between the first plastic film and the second plastic film. Then, the decoration film is placed at an IMD injection molding die. At last, a piece of plastic material is injected into the IMD injection molding die to combine the decoration film and the piece of plastic material to be an IMD injection molding case. The first plastic film, the graphite film and the second plastic film is combined together to be the decoration film by a hot pressing technology or by adhesive.

The IMD injection molding case of the invention utilizes the graphite film of the decoration film to provide a good heat dissipation effect and a function of preventing electromagnetic interference. The IMD injection molding case may be used in a notebook computer to solve the problem that the heat cannot be dissipated evenly in the notebook computer.

These and other features, aspects, and advantages of the present invention will become better understood with regard to the following description, appended claims, and accompanying drawings.

### BRIEF DESCRIPTION OF THE DRAWINGS

FIG. 1 is a section diagram showing an IMD injection molding case of a preferred embodiment of the invention;

FIG. 2 is a section diagram showing an IMD injection molding case of another embodiment of the invention; and

FIG. 3 is flow chart of an IMD injection molding process of a preferred embodiment of the invention.

### DETAILED DESCRIPTION OF THE EMBODIMENTS

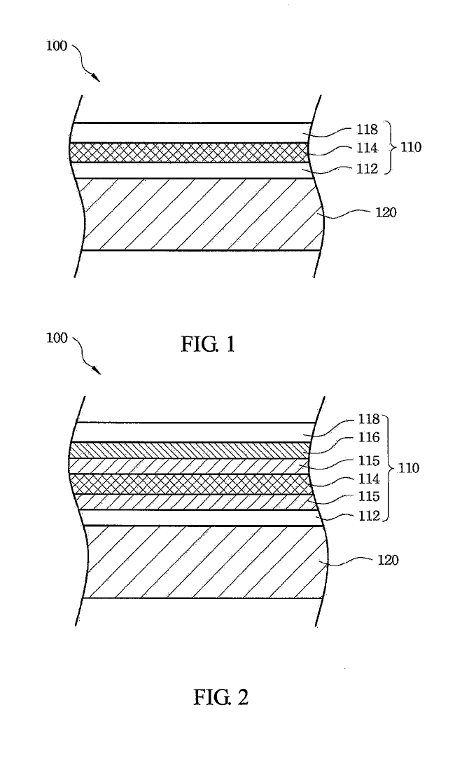

FIG. 1 is a section diagram showing an IMD injection molding case of a preferred embodiment of the invention. A decoration film 110 and a piece of plastic material 120 are combined to form an IMD injection molding case 100 by an IMD technology. The IMD injection molding case 100 includes the piece of plastic material 120, a first plastic film 112, a graphite film 114 and a second plastic film 118 in turn. The first plastic film 112, the graphite film 114 and the second plastic film 118 are combined to be the decoration film 110 used by the IMD injection molding process.

The heat conductivity coefficient of the graphite (600˜800 W/m.K) is much higher than that of silver (406 W/m.K) or copper (385 W/m.K), and the graphite also has the function of preventing electromagnetic interference (EMI). Therefore, in the embodiment, the IMD injection molding case 100 having the graphite film 114 has good heat conductivity and effect of preventing the EMI. The IMD injection molding case 100 may be the case of a notebook computer. In the notebook computer, the inner electronic elements generated heat or the put hand often causes the temperature of the case to be uneven. The IMD injection molding case 100 of the invention with the graphite film 114 having high heat conductivity provides good heat dissipation effect and effectively avoids the condition that heat of the case of the notebook computer is dissipated unevenly.

The piece of plastic material 120 often used to produce the case of the notebook computer may be Polycarbonate/ABS (PC/ABS) resin, and then, the material of the first plastic film 112 contacting the piece of plastic material 120 is preferred to be the acrylonitrile-butadiene-styrene (ABS) resin. Thus, the jointing degree between the decoration film 110 and the piece of plastic material 120 is improved. The thickness of the graphite film 114 is preferred to be 0.1 mm to 0.5 mm. The second plastic film 118 may protect the surface of the decoration film 110, and the material of the second plastic film 118 may be Polyethylene Terephthalate (PET), acrylonitrile-butadiene-styrene (ABS) or others.

FIG. 2 is a section diagram showing an IMD injection molding case of another preferred embodiment of the invention. A printed ink film 116 may be further provided in the decoration film 110. The printed ink film 116 is provided between the graphite film 114 and the second plastic film 118. Trademarks or patterns of manufacturers may be printed on the printed ink film 116 to beautify the IMD injection molding case 100. The first plastic film 112, the graphite film 114 and the second plastic film 118 may be combined to form the decoration film 110 by the hot pressing technology or by adhesive. Then, in the decoration film 110, the adhesive films 115 are provided between the first plastic film 112 and the graphite film 114 and between the graphite film 114 and the second plastic film 118, respectively. The adhesive film 115 is a double-side adhesive film.

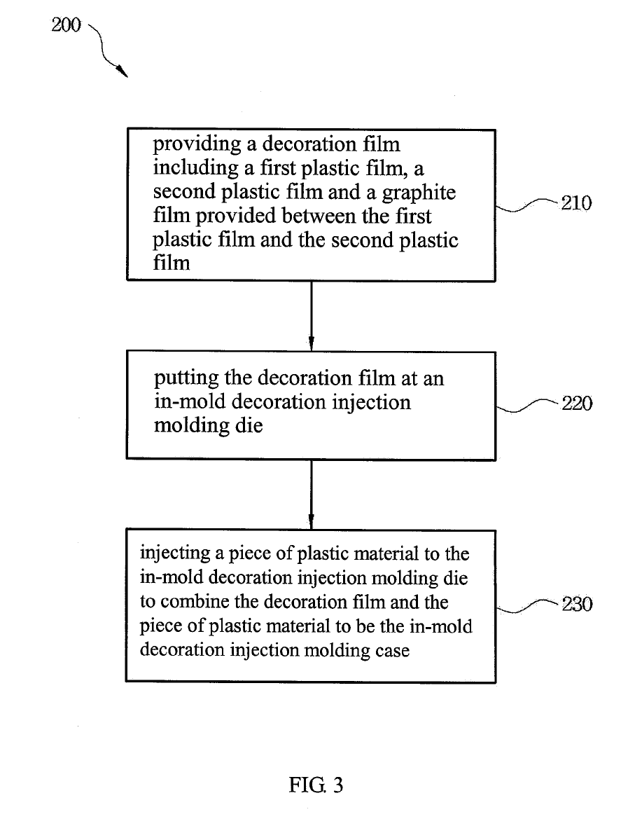

FIG. 3 is a flow chart of an IMD injection molding process of a preferred embodiment of the invention. The IMD injection molding process 200 uses the injection molding process of the IMD technology. First, a decoration film 110 is provided in the step 210, wherein the decoration film 110 includes a first plastic film 112, a second plastic film 118 and a graphite film 114 provided between the first plastic film 112 and the second plastic film 118. Then, the decoration film 110 is put at an IMD injection molding die in the step 220. At last, the piece of plastic material 120 is injected into the IMD injection molding die in the step 230 to combine the decoration film 110 and the piece of plastic material 120 to be the IMD injection molding case 100. In the step 210, the decoration film 110 may be formed by combining the first plastic film 112, a graphite film 114 and the second plastic film 118 by the hot pressing technology or by adhesive.

From the above preferred embodiment of the invention, the invention has following advantages. The IMD injection molding case of the invention utilizes the graphite film in the decoration film to provide good heat dissipation effect and the function of preventing the electromagnetic interference. The IMD injection molding case may be applied to the notebook computer to solve the problem that heat of the notebook computer cannot be dissipated evenly.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An in-mold decoration injection molding case comprising:
a decoration film comprising a first plastic film, a second plastic film and a graphite film provided between the first plastic film and the second plastic film; and
a piece of plastic material combined with the decoration film to form the in-mold decoration injection molding case by an in-mold decoration injection molding process.

2. The in-mold decoration injection molding case according to claim 1, wherein the piece of plastic material contacts the first plastic film of the decoration film.

3. The in-mold decoration injection molding case according to claim 2, wherein the decoration film comprises a printed ink film provided between the graphite film and the second plastic film.

4. The in-mold decoration injection molding case according to claim 1, wherein the decoration film comprises a plurality of adhesive films provided between the first plastic film and the graphite film and between the graphite film and the second plastic film, respectively, to combine the first plastic film, the graphite film and the second plastic film to be the decoration film.

5. The in-mold decoration injection molding case according to claim 1, wherein the thickness of the graphite film is 0.1 mm to 0.5 mm.

6. The in-mold decoration injection molding case according to claim 1, wherein the in-mold decoration injection molding case is a case of a notebook computer.

7. The in-mold decoration injection molding process comprising the steps of:
providing a decoration film comprising a first plastic film, a second plastic film and a graphite film provided between the first plastic film and the second plastic film;
putting the decoration film at an in-mold decoration injection molding die; and
injecting a piece of plastic material to the in-mold decoration injection molding die to combine the decoration film and the piece of plastic material to be an in-mold decoration injection molding case.

8. The in-mold decoration injection molding process according to claim 7, wherein the first plastic film, the graphite film and the second plastic film are combined to be the decoration film by a hot pressing technology.

9. The in-mold decoration injection molding process according to claim 7, wherein the first plastic film, the graphite film and the second plastic film are combined to be the decoration film by adhesive.
